(19) United States
(12) Patent Application Publication
(10) Pub. No.: US 2026/0316588 A1
(43) Pub. Date: Oct. 15, 2026

(54) Operating Mode Selector Device in a Motor Vehicle, and Motor Vehicle

(71) Applicant: Bayerische Motoren Werke Aktiengesellschaft, Muenchen (DE)

(72) Inventors: Matthias JUNGHANNS, Muenchen (DE); Simon KAFMANN, Muenchen (DE); Kai LANGER, Muenchen (DE)

(21) Appl. No.: 19/117,152

(22) PCT Filed: Dec. 8, 2023
(86) PCT No.: PCT/DE2023/100953

§ 371 Date: Mar. 31, 2025

(30) Foreign Application Priority Data
Dec. 15, 2022 (DE) 10 2022 133 424.4

(51) Int. Cl. B60L 15/20

(52) U.S. Cl. CPC B60L 15/20; B60L 2250/00

(57) ABSTRACT

A motor vehicle operating mode selector device includes an actuating element which is connected or coupled to an electrical switch device for the purpose of actuating the switch device. The operating mode selector device is characterized in that the actuating element is movable along a first spatial axis for the purpose of selecting at least one operating mode of the motor vehicle and along a second spatial axis, which is orthogonal to the first spatial axis, for the purpose of selecting at least one drive stage of the motor vehicle.

### BACKGROUND AND SUMMARY

The invention relates to an operating mode selector device in a motor vehicle. It also relates to a motor vehicle having such an operating mode selector device.

In contrast to vehicles with a combustion engine, electric motor vehicles generally no longer require a transmission in the drive train. Therefore, a gear shift lever or gear selector lever is no longer required. However, even electric vehicles require a way of selecting an operating mode of the drive, for example for forward travel, for reverse travel or for parking the electric motor vehicle. Although such selections can be made on a touch screen, it is desirable, for ergonomic reasons and for reasons of driving safety to be able to carry out an operating mode selection with discrete actuating devices provided separately therefor.

In the case of a motor vehicle equipped with a combustion engine and an automatic transmission, it is well known to select the drive stage electrically with an actuating lever that is tiltable back and forth in a vertical vehicle longitudinal plane. In the case of mechanical transmission, a park position of the transmission, to be engaged with a separate button, and additionally and separately an electric park brake that is able to be actuated by means of a further button are also provided.

The present invention addresses the problem of providing an improved, intuitively usable operating mode selector device for a motor vehicle, in particular for an electric motor vehicle. Furthermore, a motor vehicle which is equipped with such an operating mode selector device is provided.

The part of the problem directed to the operating mode selector device is solved by the features of the independent claim(s).

An operating mode selector device in a motor vehicle is provided with an actuating element which is connected or coupled to an electric switch device in order to actuate the latter. Such an operating mode selector device is characterized, according to the invention, in that the actuating element is movable along a first spatial axis in order to select at least one operating mode of the motor vehicle and along a second spatial axis, orthogonal to the first spatial axis, in order to select at least one drive stage of the motor vehicle.

An advantage of this operating mode selector device is that both the drive stage selection and the operating mode selection are combined in a single actuating element, allowing intuitive use.

Advantageously, to this end, the electric switch device has static electrical contacts and movable electrical contacts which are formed on a movable contact body in order, upon actuation, to come into electrically conductive contact with or to disengage from the static electrical contacts, wherein the movable contact body is provided with or coupled to the actuating element.

Further preferred and advantageous design features of the operating mode selector device according to the invention are the subject of the dependent claims.

Preferably, the first spatial axis extends in the vehicle transverse direction and the second spatial axis extends in the vehicle longitudinal direction. This increases the intuitive actuability since the selection of the direction of travel corresponds to the movement of the operating mode selector device along the vehicle axis—moving the operating mode selector device forward establishes, for example, the forward direction of travel and moving the operating mode selector device toward the rear establishes, for example, the reverse direction of travel. By contrast, moving it in the vehicle transverse direction makes it possible—in a superordinate manner—to select the operating mode per se, i.e. it switches between a park operating mode, in which, for example, a parking brake of the motor vehicle is activated, and a drive operating mode. Preferably, the first and the second spatial axis define a horizontal plane.

It is particularly advantageous when the movability of the actuating element along the first spatial axis is formed by a sliding guide of the actuating element and when the movability of the actuating element along the second spatial axis is formed by a sliding guide or tilt mounting of the actuating element. The resulting sliding movements of the actuating element when the operating mode selector device is actuated in the vehicle transverse direction and optionally also in the vehicle longitudinal direction or, alternatively, the tilting movement of the actuating element in the vehicle longitudinal direction, i.e. about a vehicle transverse axis, facilitate the intuitive use and allow “blind” actuation of the operating mode selector device without the driver having to look away from the road.

According to a preferred embodiment of the invention, which is combinable to other embodiments, the electric switch device, in order to select the at least one operating mode by moving the actuating element along the first spatial axis, has at least one electrical switching function which brings about, for example, switching between a park mode and a neutral position of a drive operating mode of the motor vehicle. Such a switching function ensures that the electric switch device in each case takes up a defined position associated with the corresponding operating mode, out of which position it can be moved again only deliberately and by knowingly actuating the actuating element.

For selecting the drive stages, the electric switch device may, in order to select the at least one drive stage by moving the actuating element along the second spatial axis, have at least one electrical switching function. Then, the respective drive stage takes up a defined position which forms, for example, a rest position.

An alternative embodiment of the invention, which is likewise combinable with other embodiments, provides that the electric switch device, in order to select the at least one drive stage by moving the actuating element along the second spatial axis, has at least one electrical tactile contact function which brings about activation of a drive stage of the motor vehicle. In this case, the selection of the respective drive stage is brought about by a sliding movement of the actuating element—similarly to conventional sequential shifting or motorcycle shifting—wherein the actuating element in each case springs into a central starting position (neutral position) following actuation.

It is also particularly advantageous when the electric switch device, in order to select the at least one drive stage by moving the actuating element along the second spatial axis in two opposite directions, brings about in each case an electrical tactile contact function, wherein moving the actuating element in the direction of travel activates a forward drive stage and wherein moving the actuating element counter to the direction of travel activates a reverse drive stage. This also results in intuitive use, since the actuating direction of the actuating element corresponds to the desired direction of travel.

A development of the invention in which it is possible to move the actuating element along the second spatial axis only in the drive operating mode position of the actuating element is particularly advantageous. This results in a defined functional separation between the park operating mode and the drive operating mode.

Yet another embodiment of the invention, which is likewise combinable with other embodiments, provides that the movement path of the actuating element along the first spatial axis in order to select the at least one operating mode has, at least in one direction of movement, a barrier that is effective on moving the actuating element and/or a force threshold or brake that is to be overcome on moving the actuating element. To this end, preferably a mechanical blocking device is provided, which, in the blocked state, prevents switching between the operating modes, in particular a change from the drive operating mode position into the park operating mode position. This blocked state can be reversed for example by actuating a further actuating device, for example the brake pedal.

Instead of such a blocking device or in addition thereto, a force threshold that is to be overcome only with increased application of force may be provided on the sliding path in the vehicle transverse direction. Such a force threshold may be effective in both displacement directions (left-right and right-left).

Alternatively, such a force threshold that is to be overcome with increased application of sliding force may be provided only in the displacement direction from the park operating mode into the drive operating mode, while for the opposite sliding direction (from the drive operating mode position into the park operating mode position), the abovementioned mechanical blocking device that is to be released again separately is provided.

It is particularly advantageous when the movement path of the actuating element along the second spatial axis in order to select the at least one drive stage has a force threshold that is to be overcome on moving the actuating element and forms in each case a pressure point. This prevents a drive stage from being engaged as it were accidentally, since the operator has to knowingly overcome the pressure point with increased application of sliding or tilting force to this end.

Furthermore, the invention is directed to a motor vehicle which is equipped with one of the above-described operating mode selector devices.

Preferred exemplary embodiments of the invention with additional design details and further advantages are described and explained in more detail in the following text with reference to the appended drawings.

### BRIEF DESCRIPTION OF THE DRAWINGS

FIG. 1 is a plan view of an operating mode selector device in a first operating mode position (park operating mode) with an associated force-path diagram;

FIG. 2 is a plan view of the operating mode selector device in a second operating mode position (drive operating mode-neutral) with an associated force-path diagram;

FIG. 3 shows the operating mode selector device from FIG. 2 in a side view in the direction of the arrow III in FIG. 2 with an associated force-path diagram.

### DETAILED DESCRIPTION OF THE DRAWINGS

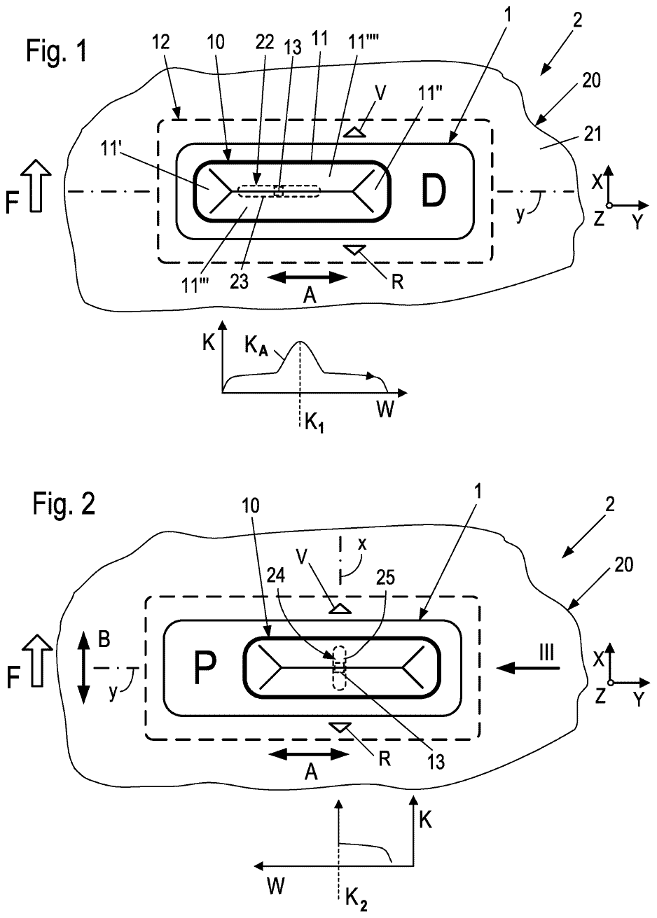

FIG. 1 shows, in the upper region, an operating mode selector device 1 according to an embodiment of the invention, which is provided in a motor vehicle 2 that is illustrated only by suggestion here, in plan view. An actuating element 10 is arranged above a panel 20 with a visible surface 21 in the interior of the motor vehicle 2 and connected to an electric switch device 12 which is arranged beneath the panel 20 and is shown only schematically in the figures.

To this end, the electric switch device 12 has at least one movable contact body which is mechanically coupled to the actuating body 10 by means of a coupling member 13 that is illustrated only schematically, the movable contact body having electrical contacts which form movable electrical contacts of the switch device 12 and cooperate, in a manner well known to a person skilled in the art, with static electrical contacts of the electric switch device 12 by coming into electrically conductive contact therewith or by disengaging therefrom. The switch device 12 can thus be actuated by displacing and/or tilting the actuating element 10.

The actuating element 10 is formed by an elongate rectangular slider knob 11 which is shaped in the manner of a hipped roof and has an obliquely inclined actuating surface 11′, 11″, 11′″, 11″″ on each of its four sides.

In order to select at least one operating mode (park operating mode “P” or drive operating mode “D”) of the motor vehicle 2, the actuating element 10 shown in the first operating mode position (park operating mode) in FIG. 1 is displaceable to the left and to the right (relative to the direction of travel F) in the direction of its longitudinal extension along a first spatial axis y extending in the vehicle transverse direction Y, as is illustrated symbolically by the double arrow A in FIG. 1. The displaceability of the actuating element 10 along the first spatial axis y is formed by a sliding guide 22 of the actuating element 10, for example by a slot 23 which is provided in the panel 20 and extends in the direction of the first spatial axis y, and in which the coupling member 13 is guided.

On the movement path of the actuating element 10 to the right (relative to the direction of travel F) along the spatial axis y from the park operating mode “P” shown in FIG. 1 into the drive operating mode “D” shown in FIG. 2, where the actuating element takes up a neutral position “N”, a force threshold K₁ with a force flank K_{A} that increases gradually along the path needs to be overcome, as is apparent from the force-path diagram in the lower region of FIG. 1.

In FIG. 2, the operating mode selector device 1 from FIG. 1 is shown with the actuating element 10 in its second operating mode position (drive operating mode) “D”. On attempting to displace the actuating element 10 back from this second operating mode position “D” into the first operating mode position “P”, a barrier acts, which builds up a high blocking force K₂ which cannot be overcome by the actuating element 10, as can be seen in the force-path diagram in the lower region of FIG. 2. To this end, for example, a mechanical blocking device (not shown) is provided, which, in the drive operating mode “D”, is positioned in the displacement path of the actuating element 10, blocks this path and thus establishes a blocked state. This blocked state is reversed, for example, by actuating the brake pedal, which causes the blocking device to retract out of the displacement path.

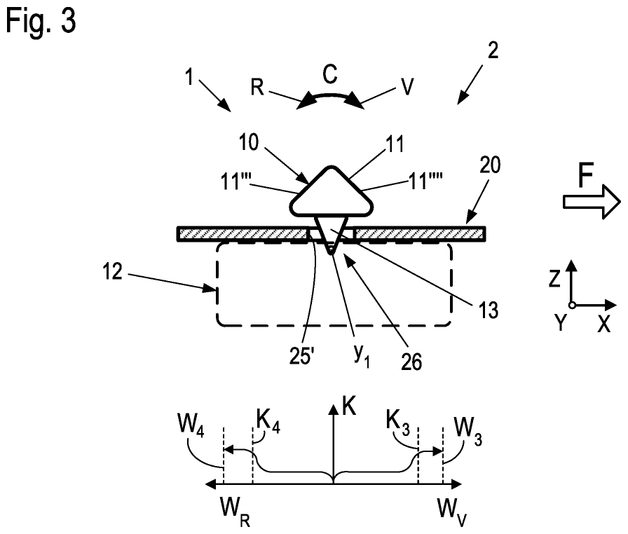

From the neutral position, illustrated in FIG. 2, in the drive operating mode “D”, the actuating element 10 can be moved forward (in the direction of travel F) and toward the rear (counter to the direction of travel F) along a second spatial axis x extending in the vehicle longitudinal direction X, as is shown in FIG. 3, in order to engage a forward or reverse drive stage. To this end, the actuating element 10 can be displaced forward and toward the rear along the second spatial axis x, as is illustrated symbolically by the double arrow B in FIG. 2, or it can be tilt mounted and be tilted forward and to the rear about a tilt axis y₁ extending parallel to the first spatial axis y, as is illustrated symbolically by the double arrow C in FIG. 3. The movability of the actuating element 10 along the second spatial axis x is formed by a sliding or tilting guide 24 of the actuating element 10, for example by a sliding slot 25, provided in the panel 20 and extending in the direction of the second spatial axis x, for linearly guiding the coupling member 13 (FIG. 2) or by a shorter tilting slot 25′ (FIG. 3).

In the case of the tilting variant illustrated in FIG. 3, the actuating element 10 is designed to be pivotable back and forth along the tilting slot 25′ by means of the coupling member 13 that forms a tilt mounting 26 and is tiltable about the tilt axis y₁.

The electric switch device 12 has front and rear electrical tactile contacts (not shown) for forming an electrical tactile contact function. To select the at least one forward drive stage “V”, the electric switch device 12 is actuated by moving the actuating element 10 by being displaced or tilted along the second spatial axis x in the direction of travel F, and to select a reverse drive stage “R”, it is actuated by moving the actuating element 10 by being displaced or tilted along the second spatial axis x counter to the direction of travel F. The movement path W_{V} of the actuating element 10 along the second spatial axis x in the direction of travel F and the movement path W_{R} of the actuating element 10 counter to the direction of travel F have, both when being displaced and when being tilted, a front force threshold K₃ and rear force threshold K₄, respectively, to be overcome, which each form a pressure point which needs to be overcome before the associated tactile contacts at the path point W₃ and W₄, respectively, close and allow a corresponding flow of current, which for its part brings about the engagement of the drive stage in question.

The operating mode selector device 1 thus allows safe and intuitively controllable one-handed operation both of the operating modes and of the drive stages of a motor vehicle 2 by means of an actuating element 10 that is movable in a preferably horizontal plane along a first spatial axis and along a second spatial axis that is orthogonal thereto.

The invention is not limited to the above exemplary embodiment, which serves merely to explain the core concept of the invention in a general manner. Within the scope of protection, the device according to the invention may, rather, take on other configurations than the ones described above. In this case, the device may in particular have features that represent a combination of the respective individual features of the claims.

Reference signs in the claims, the description and the drawings serve to make the invention easier to understand and are not intended to limit the scope of protection.

### LIST OF REFERENCE SIGNS

1 Operating mode selector device
2 Motor vehicle
10 Actuating element
11 Rectangular slider knob
11′ Obliquely inclined actuating surface
11″ Obliquely inclined actuating surface
11′″ Obliquely inclined actuating surface
11″″ Obliquely inclined actuating surface
12 Electric switch device
13 Coupling member
20 Panel
21 Surface
22 Sliding guide
23 Slot
24 Sliding or tilting guide
25 Sliding slot
25′ Tilting slot
26 Tilt mounting
A Double arrow
B Double arrow
C Double arrow
D Drive operating mode
F Direction of travel
K_{A} Force flank
K₁ Force threshold
K₂ Blocking force
K₃ Front force threshold
K₄ Rear force threshold
N Neutral position
P Park operating mode
R Reverse drive stage
V Forward drive stage
W_{V} Movement path in direction of travel
W_{R} Movement path counter to direction of travel
W₃ Path point
W₄ Path point
X Vehicle longitudinal direction
x Second spatial axis
Y Vehicle transverse direction
y First spatial axis
y₁ Tilt axis

1.-10. (canceled)

11. An operating mode selector device in a motor vehicle, comprising:
an actuating element; and
an electric switch device, the actuating element being connected or coupled to the electric switch device in order to actuate the switch device,
wherein the actuating element is movable along a first spatial axis in order to select at least one operating mode of the motor vehicle and along a second spatial axis, orthogonal to the first spatial axis, in order to select at least one drive stage of the motor vehicle.

12. The operating mode selector device according to claim 11, wherein
the first spatial axis extends in a vehicle transverse direction, and
the second spatial axis extends in a vehicle longitudinal direction.

13. The operating mode selector device according to claim 12, wherein
the movability of the actuating element along the first spatial axis is formed by a sliding guide of the actuating element, and
the movability of the actuating element along the second spatial axis is formed by a sliding guide or tilt mounting of the actuating element.

14. The operating mode selector device according to claim 11, wherein
the electric switch device, in order to select the at least one operating mode by moving the actuating element along the first spatial axis, has at least one electrical switching function which brings about switching between a park operating mode and a neutral position of a drive operating mode of the motor vehicle.

15. The operating mode selector device according to claim 14, wherein
the electric switch device, in order to select the at least one drive stage by moving the actuating element along the second spatial axis, has at least one electrical tactile contact function which brings about activation of a drive stage of the motor vehicle.

16. The operating mode selector device according to claim 15, wherein
the electric switch device, in order to select the at least one drive stage by moving the actuating element along the second spatial axis in two opposite directions, brings about in each case an electrical contact function,
wherein moving the actuating element in a direction of travel activates a forward drive stage and moving the actuating element counter to the direction of travel activates a reverse drive stage.

17. The operating mode selector device according to claim 16, wherein
the actuating element is movable along the second spatial axis only in the drive operating mode position of the actuating element.

18. The operating mode selector device according to claim 15, wherein
the actuating element is movable along the second spatial axis only in the drive operating mode position of the actuating element.

19. The operating mode selector device according to claim 11, wherein
a movement path of the actuating element along the first spatial axis in order to select the at least one operating mode has, at least in one direction of movement, a barrier that is effective on moving the actuating element and/or a force threshold or brake that is to be overcome on moving the actuating element.

20. The operating mode selector device according to claim 19, wherein
a movement path of the actuating element along the second spatial axis in order to select the at least one drive stage has a force threshold that is to be overcome on moving the actuating element and forms in each case a pressure point.

21. A motor vehicle comprising an operating mode selector device according to claim 11.
